(19) United States
(12) Patent Application Publication
(10) Pub. No.: US 2024/0418417 A1
(43) Pub. Date: Dec. 19, 2024

(54) APPARATUS FOR HEATING AND/OR COOLING FLUID, AND AIR CONDITIONING SYSTEM

(71) Applicant: Continental Automotive Technologies GmbH, Hannover (DE)

(72) Inventors: Andreas Kircher, Darmstadt (DE); Johann Jungbecker, Badenheim (DE)

(73) Assignee: Continental Automotive Technologies GmbH, Hannover (DE)

(21) Appl. No.: 18/701,520

(22) PCT Filed: Sep. 30, 2022
(86) PCT No.: PCT/DE2022/200231

§ 371 Date: Apr. 15, 2024

(30) Foreign Application Priority Data
Oct. 15, 2021 (DE) 10 2021 211 702.3

(51) Int. Cl. F25B 23/00

(52) U.S. Cl. CPC F25B 23/00

(57) ABSTRACT

The present disclosure relates to a device for heating and/or cooling fluid, wherein the device has one or more chambers with respective elastocaloric elements, an actuating unit and a valve unit, wherein fluid is conducted selectively through the chambers. The present disclosure furthermore relates to an air-conditioning system having such a device.

### CROSS-REFERENCE TO RELATED APPLICATIONS

The present application is a National Stage Application under 35 U.S.C. § 371 of International Patent Application No. PCT/DE2022/200231 filed on Sep. 30, 2022, and claims priority from German Patent Application No. 10 2021 211 702.3 filed on Oct. 15, 2021, in the German Patent and Trademark Office, the disclosures of which are herein incorporated by reference in their entireties.

### TECHNICAL FIELD

The invention relates to a device for heating and/or cooling fluid, and to an air-conditioning system having such a device.

### BACKGROUND

In numerous situations, it is necessary for a fluid, such as for example air, water or some other liquid, to be cooled or heated in a targeted manner. For example, the temperature of an interior compartment of a motor vehicle is controlled in order for a pleasant interior-compartment climate to be produced independently of the outside temperature. The same applies for example to residential and commercial buildings, which typically are heated at least in winter and, in particular in countries with intense summer heat, are also cooled.

Nowadays, use is typically made of heat pumps when both a heating function and a cooling function are intended to be provided. A heat pump typically works with a reservoir from which heat can be extracted or into which heat can be released, wherein the reservoir is situated outside the region whose temperature is to be controlled. Heat pumps typically use coolant which can run out, gives rise to maintenance outlay and, depending on design, can be harmful to the climate if it escapes.

### SUMMARY

It is an object of the present disclosure to provide a device for heating and/or cooling fluid that is designed in an alternative or better way in comparison with known devices. It is furthermore an object of the present disclosure to provide an air-conditioning system having such a device. This is achieved according to the present disclosure by the subject matter of the respective main claims. Advantageous configurations can be found, for example, in the respective dependent claims. The content of the claims is incorporated in the content of the description by express reference.

The present disclosure relates to a device for heating and/or cooling fluid. The device has one or more chambers. The device has one or more elastocaloric elements, wherein each elastocaloric element is in fluidic contact with a chamber. The device has an actuating unit which is configured to elongate and to relax the elastocaloric elements in an alternating manner. The device has a valve unit which is configured to conduct fluid selectively through the chamber or the chambers.

Such a device allows use of the elastocaloric effect, which occurs with various materials. In this case, a material heats up in dependence on an elongation state and accordingly also cools down again. Cyclical elongation and relaxation thus allows heat to be transported in a targeted manner from one reservoir to another reservoir, which makes possible targeted heating and also targeted cooling. What is typically conducted through the respective chambers in this case is a fluid which can accordingly be heated or cooled in a targeted manner. By contrast to known heat pumps, no coolant is used in this case, which reduces susceptibility to maintenance and avoids possible damage due to escaping coolant.

A fluid may be understood as meaning in particular a gaseous or liquid substance. For example, air may be heated or cooled, or water or a special coolant or else some other liquid may be heated or cooled.

A chamber may be understood as meaning in particular a space in which the fluid is heated or cooled.

An elastocaloric element is to be understood as meaning in particular an element which heats up or cools down according to an elongation state. Accordingly, it can release heat to the surroundings or can absorb heat from the surroundings. Examples will be mentioned further below.

The actuating unit may in particular be coupled functionally to the valve unit. Examples will be mentioned further below. Selective conducting of fluid may be understood as meaning in particular that fluid is conducted or else is not conducted through specific chambers according to a present state of the valve unit.

In particular, by means of the embodiments described herein, it is possible to dispense with a movement of the elastocaloric elements within the device. It is thus not the case that the elastocaloric element is moved into another chamber if there is to be a switch for example from a cooling function to a heating function. It is rather the case that fluid to be cooled selectively or to be heated selectively is conducted through the chambers in which there is situated an elastocaloric element which can specifically perform the respectively desired task of cooling or heating.

In particular, the device may have multiple chambers that may be arranged in particular along a circle. Other configurations are also possible, however. The use of only one chamber is also possible in principle.

The chambers may have a circular cross section in particular transverse to the throughflow direction of the fluid. This makes possible a simple embodiment. Other cross sections are also possible in principle, however.

According to one embodiment, one, some or all the elastocaloric elements are arranged in a respective chamber. In other words, such an elastocaloric element is situated within the chamber, wherein the chamber defines the space available to the fluid.

According to one embodiment, it is provided that one, some or all the elastocaloric elements surround and/or form a respective chamber. In this way, the elastocaloric element itself may be used to fully or partly define the respective chamber. The chamber may for example be in the form of a hollow space within the elastocaloric element.

According to one embodiment, one, some or all the elastocaloric elements are in the form of a wire or in the form of a wire bundle. Such a wire may in particular be elongate. A wire bundle may in particular be an agglomeration of multiple, directly adjacent wires. This makes possible a simple embodiment, which can also be elongated and relaxed in a simple manner.

According to one embodiment, one, some or all the elastocaloric elements are of elongate and/or rod-shaped form and are expediently subjected to tensile elongation. This makes it possible for the elastocaloric elements to be elongated and relaxed along their respective longitudinal direction.

According to one embodiment, one, some or all the elastocaloric elements are of spiral-shaped form and/or in the form of a helical spring and are expediently subjected to torsional elongation. This makes possible elongation and relaxation by way of a rotational movement, whereby for example a different or better utilization of installation space can be achieved.

According to one embodiment, one, some or all the elastocaloric elements are formed from a shape-memory material. Such shape-memory materials typically have the aforementioned property of cooling down or heating up according to an elongation state. In particular, a nickel-titanium alloy may be used. For example, a nickel proportion of such a nickel-titanium alloy of at least 50% and/or of at most 60% may be used. In particular, a nickel proportion of 55% and accordingly a titanium proportion of 45% may be used. Such materials have proven to be advantageous for typical designs. Other corresponding materials are also possible, however.

The actuating unit may in particular be in the form of a cam disk. This allows simple actuation, that is to say elongation and relaxation, of the elastocaloric elements according to a rotational state of the cam disk.

Alternatively, it is for example also possible for use to be made of a respective actuator for each wire bundle or wire, or more generally for each elastocaloric element and/or for each chamber. This allows separate actuation of the elastocaloric elements. A rotating cam disk can cyclically transmit a change in distance to the elastocaloric element via a cam profile. The movement of the cam disk may in particular be synchronized with the valve unit.

The valve unit may in particular have a cooling inlet and a cooling outlet. The valve unit may in particular be configured such that, during or immediately after the relaxation of an elastocaloric element, it connects a chamber that is in fluidic contact with the elastocaloric element to the cooling inlet and the cooling outlet. This allows targeted cooling of a fluid to be cooled that enters the cooling inlet and exits the cooling outlet again. When relaxed, an elastocaloric element typically cools down, so that it can absorb heat from the surroundings. This may be utilized for the cooling of the fluid.

The valve unit may in particular have a heating inlet and a heating outlet. The valve unit may in particular be configured such that, during or immediately after the elongation of an elastocaloric element, it connects a chamber that is in fluidic contact with the elastocaloric element to the heating inlet and the heating outlet. In this way, a fluid which enters the heating inlet and exits the heating outlet can be heated in a target manner. Consequently, the effect that a typical elastocaloric element heats up during elongation and can thus release heat to the surroundings is utilized.

The valve unit may in particular have a heating inlet and a heating outlet. The valve unit may in particular be configured such that, during or immediately after the elongation of a first elastocaloric element and a second elastocaloric element, it connects a first chamber that is in fluidic contact with the first elastocaloric element to the heating inlet, it connects the first chamber at least partially to a second chamber that is in fluidic contact with the second elastocaloric element, and it connects the second chamber to the heating outlet. In this way, cascaded heating of the fluid can be achieved, wherein it is also possible for the embodiment mentioned to be of correspondingly cascaded form, that is to say it is also possible for multiple chambers to be correspondingly interconnected. The first chamber may be fluidically connected to the second chamber completely, or else only partially, wherein a partial connection may be understood as meaning in particular that one part of the fluid exiting the respective chamber is conducted into another chamber and another part of the exiting fluid is used in some other way, for example is fed directly to a heating outlet or is used for heating in some other way.

The valve unit may in particular have a cooling inlet and a cooling outlet. The valve unit may in particular be configured such that, during or immediately after the relaxation of a first elastocaloric element and a second elastocaloric element, it connects a first chamber that is in fluidic contact with the first elastocaloric element to the cooling inlet, it connects the first chamber at least partially to a second chamber that is in fluidic contact with the second elastocaloric element, and it connects the second chamber to the cooling outlet. Corresponding cascading is possible, too. Consequently, cascaded cooling may be provided, wherein reference is made to the embodiments just described in relation to the heating.

The valve unit may in particular be coupled rotationally to the actuating unit. At least this can apply to a rotating portion of the valve unit. This allows direct synchronization between actuating unit and valve unit, so that conducting of fluid to the correct chambers at all times is ensured in a simple manner.

The valve unit may in particular have multiple fluid channels subjected to slot control that are formed in a shaft. This makes it possible for connections and chambers to be connected in a simple manner. In particular, the connection is realized according to a respective rotational angle.

In particular, in each case multiple elastocaloric elements may be arranged in one, some or all the chambers. In this way, the heating and cooling effect can be intensified. The use of only one respective elastocaloric element is also possible, however.

The present disclosure furthermore relates to an air-conditioning system for a motor vehicle, having a device as described herein. With regard to the device, use may be made of all the embodiments and variants described herein. The air-conditioning system can be configured in particular both for cooling and for heating an interior compartment of the motor vehicle. This is not the only possible use, however. Other uses, for example for cooling and heating houses, aircraft, ships or drinking water or service water, are conceivable, too.

Quite generally, the device described herein may be understood as being a heat pump with an alternative concept. It can heat and cool both in a stationary state and in a mobile state. It may be used for example also for heating and/or cooling further components, for example in the drivetrain of a motor vehicle.

In embodiments that dispense with the valve unit described herein and instead move the elastocaloric element, it has been found that in particular the cold medium can have a high viscosity at low temperatures and that elastocaloric elements can be subjected to additional load through movement in the medium. In the device described herein, the elastocaloric elements are by contrast stationary and only the medium moves, or is conducted in a targeted manner through suitable chambers.

In particular, the elastocaloric elements are static in a respective separate flow channel. They can be cyclically elongated and relaxed for example by a cam disk which can be fastened to a main shaft and which can be rotated. Slot control means which apply cold or warm media to the elastocaloric elements in the channels cyclically in rotation may be situated on the main shaft, in particular in intake and discharge regions. In particular, per revolution, one cold and one warm use, that is to say a pairwise use, may be realized. It is also possible for there to be multiple warm/cold cycles per revolution.

The cam disk, which may also be fastened to the rotatable shaft, can impart a distance to the elastocaloric elements or wires. This can mean in particular that these can be cyclically elongated and relaxed, possibly via transmission elements. Typically, the elastocaloric element is relaxed in the cold channel and elongated in the warm channel. It is not absolutely necessary for the process of stretching and relaxing to take place precisely at the moment at which warm or cold medium flows around the elastocaloric element. The flowing-around may also take place with a slight delay.

Advantageously, the flow channel itself may form the elastocaloric element. The flow can then be conducted through the interior of the elastocaloric element.

Passage of the flow in an exactly axially parallel manner is not absolutely necessary, flowing-around in a radial direction or a combination also being possible. It is conceivable for there to be multiple elastocaloric elements per channel. Provision is typically made of at least one flow channel in which an elastocaloric element or a wire is situated.

A part of the departing warm medium can be redirected into the inflow of the warm medium. Also, a part of the warm departing medium can be conducted into the inflow of the warm medium. This can be controlled in a regulable manner via valves or else controlled in a fixed manner by way of flow cross sections. In a static conducting element which performs the slot control of the inflows into the machine, elements which are able to control the inflow and outflow and which thus control the media mass flow through the machine may be introduced.

In particular, the embodiment described herein yields the advantages of additional regulability of power and efficiency and of avoidance of loading of the wires through rotational movement. The device described herein can in principle be used almost anywhere where something is to be heated and/or cooled.

Overall, it has also been found that, beside the advantage of a coolant being unnecessary, a higher efficiency than in the case of coolant-based heat pumps can be achieved.

### BRIEF DESCRIPTION OF THE DRAWINGS

Further features and advantages will be taken by a person skilled in the art from the example embodiment described below with reference to the appended drawing. In the drawing:

FIG. 1: shows a device according to an example embodiment in a lateral cross-sectional view, and

FIG. 2: shows a schematic plan view of the device.

### DETAILED DESCRIPTION

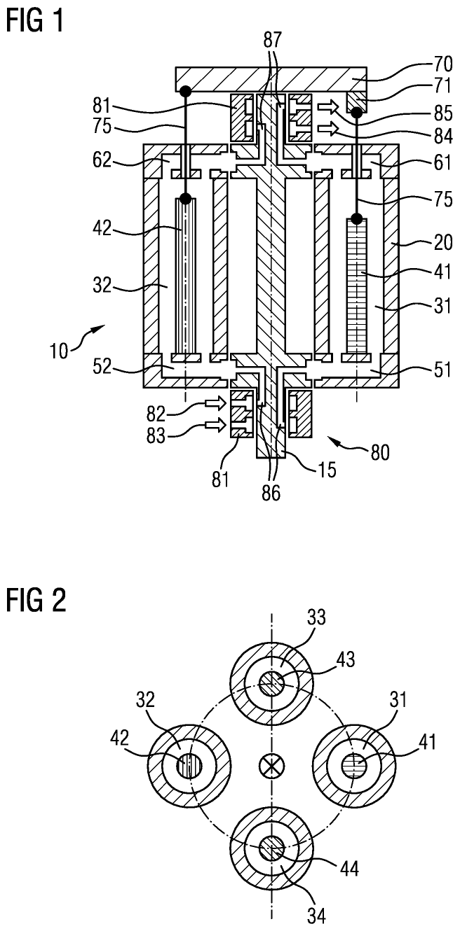

FIG. 1 shows a device 10 for heating and cooling fluid according to an example embodiment of the present disclosure. FIG. 2 shows a detail of the same device 10 in a purely schematic plan view.

The device 10 has a housing 20. The housing surrounds the device 10 at the outside and defines elements situated therein. Mounted rotatably in the housing 20 is a central shaft 15 having multiple functionalities, which will be discussed below.

Multiple chambers are formed in the housing 20, with a first chamber 31 and a second chamber 32 being shown in FIG. 1. The device 10 additionally also has a third chamber 33 and a fourth chamber 34. These are illustrated in FIG. 2 in a schematic plan view, wherein it can also be seen that these are arranged along a circle. This constitutes an example embodiment, with other numbers of chambers and other arrangements of the chambers also being possible.

A first elastocaloric element 41 is arranged in the first chamber 31. A second elastocaloric element 42 is arranged in the second chamber 32. Corresponding third and fourth elastocaloric elements 43, 44 are arranged in the further chambers 33, 34 too, wherein the functionality thereof is identical to that which will be described below with reference to the first and second elastocaloric elements 41, 42.

In the present case, the elastocaloric elements 41, 42 are of elongate, that is to say rod-shaped or wire-shaped, form. They extend vertically and are formed from a shape-memory material which exhibits an elastocaloric effect. This means in particular that they heat up when they are elongated and cool down when they are relaxed.

Below the chambers 31, 32 are arranged respective feed lines 51, 52. Above these are arranged respective discharge lines 61, 62. These serve for connection to a valve unit 80, which will be discussed in more detail further below.

An actuating unit 70 is arranged on top of the shaft 15. This is in the form of a cam disk in the present case, one cam 71 being shown. Arranged between the actuating unit 70 or respective cams 71 and the elastocaloric elements 41, 42 is in each case one spacer element 75. By means of the spacer elements 75, a force is transmitted from cams 71 to the elastocaloric elements 41, 42. Through rotation of the actuating element 70, which is in the form of a cam disk and predefines a change in distance, the elastocaloric elements 41, 42 are thus elongated and relaxed again in a cyclically repeated manner. In this way, the aforementioned elastocaloric effect is triggered, that is to say the elastocaloric elements 41, 42 heat up cyclically and correspondingly cool down again according to their elongation state. In particular, the spacer elements 75 may be connected to the actuating unit 70 in such a way that there is a connection at all times. It is also possible, according to a possible embodiment, for the elastocaloric elements 41, 42 to be configured in such a way that they exert an upwardly directed force and thus provide for abutment of the spacer elements 75 against the actuating unit 70. Other embodiments are also possible, however. An actuator running along in the circle would also be conceivable for example as an alternative to a cam disk.

The device 10 furthermore has the aforementioned valve unit 80, the functionality of which will be discussed below. The valve unit 80 has a stationary element 81 which is formed both at the top side and at the bottom side and in which inlets and outlets described below are formed.

A heating inlet 82 and a cooling inlet 83 are formed at the bottom side. Fluid to be heated may be introduced into the heating inlet 82. Fluid to be cooled may be introduced into the cooling inlet 83. A heating outlet 84 and a cooling outlet 85 are formed at the top side. Fluid to be heated may be introduced through the heating inlet 82 and exits again through the heating outlet 84. Fluid to be cooled may be introduced through the cooling inlet 83 and exits again through the cooling outlet 85. For suitable use of the device 10, it is thus sufficient for lines for fluid to be cooled and to be heated to be connected to the connections provided for this purpose, that is to say inlets and outlets.

Lower fluid channels 86 subjected to slot control and upper fluid channels 87 subjected to slot control are formed within the shaft 15. These are in fluidic contact with the inlets 82, 83 and the outlets 84, 85 according to angular position of the shaft 15 such that they are connected to the chambers 31, 32, 33, 34 in such a way that an elastocaloric element 41, 42, 43, 44 which has heated up or is heating up owing to elongation comes into contact with fluid to be heated and an elastocaloric element 41, 42, 43, 44 which is cooling down owing to relaxation comes into contact with fluid to be cooled. In this way, a positional variation of the elastocaloric elements 41, 42, 43, 44 can be dispensed with, it rather being the case that the fluid control mentioned ensures that fluid is heated or cooled as desired.

A connection which feeds a part of the cooling medium from the cooling outlet 85 back to the cooling inlet 83 may exist permanently or temporarily between the cooling outlet 85 and the cooling inlet 83. In the case of a temporary connection, it may in particular be synchronized with the elongation and relaxation cycle.

It should be pointed out that features may be described in combination in the claims and in the description, for example, in order to facilitate understanding, even though the features may also be used separately from one another. A person skilled in the art will recognize that such features may also, independently of one another, be combined with other features or combinations of features.

Dependency references in dependent claims may characterize preferred combinations of the respective features but do not exclude other combinations of features.

### LIST OF REFERENCE SIGNS

10 Device
15 Shaft
20 Housing
31, 32, 33, 34 Chambers
41, 42, 43, 44 Elastocaloric elements
51, 52 Feed lines
61, 62 Discharge lines
70 Actuating unit
71 Cam
80 Valve unit
81 Stationary element
82 Heating inlet
83 Cooling inlet
84 Heating outlet
85 Cooling outlet
86 Lower fluid channels
87 Upper fluid channels

1. A device for at least one of heating or cooling fluid, wherein the device comprises:
one or more chambers,
one or more elastocaloric elements, wherein each elastocaloric element is in fluidic contact with a chamber,
an actuating unit which is configured to elongate and to relax the elastocaloric elements in an alternating manner, and
a valve unit which is configured to conduct fluid selectively through the one or more chambers.

2. The device as claimed in claim 1, wherein
the one or more chambers comprises multiple chambers that are arranged along a circle.

3. The device as claimed in claim 1, wherein each of the one or more chambers has a circular cross section transverse to the throughflow direction of the fluid.

4. The device as claimed in claim 1, wherein one, some or all the elastocaloric elements are arranged in a respective chamber.

5. The device as claimed in claim 1, wherein one, some or all the elastocaloric elements at least one of surrounds and/or forms a respective chamber.

6. The device as claimed in claim 1, wherein one, some or all the elastocaloric elements are in the form of a wire or in the form of a wire bundle.

7. The device as claimed in claim 1, wherein one, some or all the elastocaloric elements are of elongate and/or rod-shaped form and are subjected to tensile elongation.

8. The device as claimed in claim 1, wherein one, some or all the elastocaloric elements are at least one of a spiral-shaped form or in the form of a helical spring and are subjected to torsional elongation.

9. The device as claimed in claim 1, wherein one, some or all the elastocaloric elements are formed from a shape-memory material.

10. The device as claimed in claim 1, wherein the actuating unit is in the form of a cam disk.

11. The device as claimed in claim 1, wherein
the valve unit has a cooling inlet and a cooling outlet, and
the valve unit is configured such that, during or immediately after the relaxation of an elastocaloric element, the valve unit connects a chamber that is in fluidic contact with the elastocaloric element to the cooling inlet and the cooling outlet.

12. The device as claimed in claim 1, wherein
the valve unit has a heating inlet and a heating outlet, and
the valve unit is configured such that, during or immediately after the elongation of an elastocaloric element, the valve unit connects a chamber that is in fluidic contact with the elastocaloric element to the heating inlet and the heating outlet.

13. The device as claimed in claim 1, wherein
the valve unit has a heating inlet and a heating outlet, and
the valve unit is configured such that, during or immediately after the elongation of a first elastocaloric element and a second elastocaloric element, the valve unit connects a first chamber that is in fluidic contact with the first elastocaloric element to the heating inlet, connects the first chamber at least partially to a second chamber that is in fluidic contact with the second elastocaloric element, and connects the second chamber to the heating outlet.

14. The device as claimed in claim 1, wherein
the valve unit has a cooling inlet and a cooling outlet, and
the valve unit is configured such that, during or immediately after the relaxation of a first elastocaloric element and a second elastocaloric element, the valve unit connects a first chamber that is in fluidic contact with the first elastocaloric element to the cooling inlet, connects the first chamber at least partially to a second chamber that is in fluidic contact with the second elastocaloric element, and connects the second chamber to the cooling outlet.

15. The device as claimed in claim 1, wherein the valve unit is coupled rotationally to the actuating unit.

16. The device as claimed in claim 1, wherein the valve unit has multiple fluid channels subjected to slot control that are formed in a shaft.

17. The device as claimed in claim 1, wherein multiple elastocaloric elements are arranged in one, some or all the chambers.

18. An air-conditioning system for a motor vehicle, having a device as claimed in claim 1.
